(19) United States
(12) Patent Application Publication
(10) Pub. No.: US 2024/0220832 A1
(43) Pub. Date: Jul. 4, 2024

(54) INFERENCE AS A SERVICE UTILIZING EDGE COMPUTING TECHNIQUES

(71) Applicant: Schlumberger Technology Corporation, Sugar Land, TX (US)

(72) Inventors: Aakarshan Dhakal, Menlo Park, CA (US); Bernard Van Haecke, Mountain View, CA (US)

(21) Appl. No.: 18/464,427

(22) Filed: Sep. 11, 2023

Related U.S. Application Data
(60) Provisional application No. 63/477,443, filed on Dec. 28, 2022.

(51) Int. Cl. G06N 5/046; G06F 9/54

(52) U.S. Cl. CPC G06N 5/046; G06F 9/54

(57) ABSTRACT

Systems and methods of the present disclosure include a method for providing machine learning inferences as a service. The method includes receiving, via an application programming interface (API) of an edge-based inference service system, a request for a machine learning inference from a client device. The method also includes forwarding, via the API, the request to one or more edge computing resources. The one or more edge computing resources include one or more edge computing resource nodes, and the API may interface with one or more hardware devices of the one or more edge computing resource nodes based on the request. The method further includes generating, via the one or more edge computing resource nodes, the machine learning inference. In addition, the method includes sending, via the API, the machine learning inference to the client device.

### CROSS-REFERENCE TO RELATED APPLICATION

This application claims priority to and the benefit of U.S. Provisional Patent Application Ser. No. 63/477,443, entitled “INFERENCE AS A SERVICE UTILIZING EDGE COMPUTING TECHNIQUES,” filed Dec. 28, 2022, which is hereby incorporated by reference in its entirety for all purposes.

### FIELD OF THE INVENTION

The present disclosure relates to inference as a service utilizing edge computing techniques.

### BACKGROUND INFORMATION

Software applications used in well-site systems often rely on machine learning to generate actionable insights. These applications may be expensive to run due to costs associated with storing, transmitting, and processing large amounts of data.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method for providing machine learning inferences as a service. The method includes receiving, via an application programming interface (API) of an edge-based inference service system, a request for a machine learning inference from a client device. The method also includes forwarding, via the API, the request to one or more edge computing resources. The one or more edge computing resources include one or more edge computing resource nodes, and the API may interface with one or more hardware devices of the one or more edge computing resource nodes based on the request. The method further includes generating, via the one or more edge computing resource nodes, the machine learning inference. In addition, the method includes sending, via the API, the machine learning inference to the client device.

### BRIEF DESCRIPTION OF THE DRAWINGS

Various aspects of this disclosure may be better understood upon reading the following detailed description and upon reference to the drawings, in which:

FIG. 1 illustrates an example wellsite system, in accordance with embodiments of the present disclosure;

FIG. 2 illustrates a network of computing resources within the wellsite system of FIG. 1, in accordance with embodiments of the present disclosure;

FIG. 3 illustrates a schematic of an edge-based inference service system implemented on the network of FIG. 2, in accordance with embodiments of the present disclosure; and

FIG. 4 is a flow diagram of a method of operating the edge-based inference service system of FIG. 3, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Similarly, as used herein, the term “substantially parallel” may be used to define downhole tools, formation layers, and so forth, that have longitudinal axes that are parallel with each other, only deviating from true parallel by a few degrees of each other. For example, a downhole tool that is substantially parallel with a formation layer may be a downhole tool that traverses the formation layer parallel to a boundary of the formation layer, only deviating from true parallel relative to the boundary of the formation layer by less than 5 degrees, less than 3 degrees, less than 2 degrees, less than 1 degree, or even less.

Embodiments of the present disclosure generally relate to an application programming interface (API) for providing machine learning inferences as a service at the edge of a network. An application of a well control system may request a machine learning inference via the API. The API may interface with edge computing resources local to the well control system. The edge computing resources may include a heterogeneous set of edge computing resource nodes, each having hardware devices specialized to handle certain workloads. The API may expose machine learning functionality and other features of the hardware devices while hiding lower-level details of their operation from a developer by abstracting away the implementation of certain frameworks, libraries, and software dependencies specific to the hardware devices. In this way, the API may enable a developer to utilize the hardware devices without needing to learn how to use the specific frameworks and libraries associated with the hardware devices.

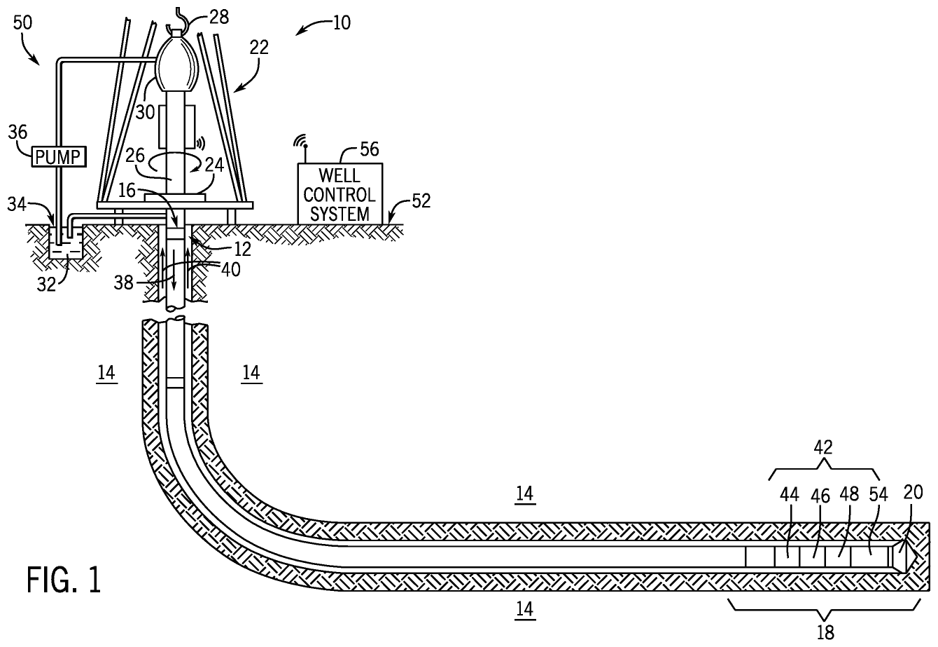

FIG. 1 illustrates a wellsite system 10 within which the embodiments described herein may be employed. The wellsite system 10 may be an onshore wellsite or offshore wellsite. In the illustrated embodiment, the wellsite system 10 is located at an onshore wellsite of an oilfield. In other embodiments, the wellsite system 10 may be used for lithium probing, geothermal drilling, and hydrogen drilling. In the illustrated embodiment, a borehole 12 is formed in a subterranean formation 14 by rotary drilling in a manner that is well known. The embodiments described herein may be employed in association with other wellsite systems to perform directional drilling. In addition, although primarily described herein as relating to wellsite systems, other embodiments may be employed in systems other than wellsites, such as manufacturing sites, midstream processing facilities, construction sites, and the like.

The wellsite system 10 includes a drill string 16 that may be suspended within borehole 12. The drill string 16 includes a bottom-hole assembly (BHA) 18 with a drill bit 20 at its lower end. In certain embodiments, the wellsite system 10 may include a platform and derrick assembly 22 positioned over the borehole 12. In certain embodiments, the platform and derrick assembly 22 may include a rotary table 24, a kelly 26, a hook 28, and a rotary swivel 30. The drill string 16 may be rotated by the rotary table 24, energized by means not shown, which engages the kelly 26 at an upper end of drill string 16. In certain embodiments, the drill string 16 may be suspended from the hook 28, attached to a traveling block (also not shown), through the kelly 26 and a rotary swivel 30, which may permit rotation of the drill string 16 relative to the hook 28. In certain embodiments, a top drive system may also be used.

In the illustrated embodiment, drilling fluid 32 is stored in a pit 34 formed at the wellsite. In certain embodiments, a pump 36 may deliver the drilling fluid 32 to an interior of the drill string 16 via a port in the swivel 30, causing the drilling fluid 32 to flow downwardly through the drill string 16 as indicated by directional arrow 38. The drilling fluid 32 may then exit the drill string 16 via ports in the drill bit 20, and circulate upwardly through an annulus region between the outside of the drill string 16 and a wall of the borehole 12, as indicated by directional arrows 40. In this manner, the drilling fluid 32 may lubricate the drill bit 20 and carry formation cuttings up to the surface as the drilling fluid 32 is returned to the pit 34 for recirculation.

As illustrated in FIG. 1, in certain embodiments, the BHA 18 may include the drill bit 20 as well as a variety of downhole equipment 42, including a logging-while-drilling (LWD) module 44, a measuring-while-drilling (MWD) module 46, a roto-steerable system and motor, and so forth. In certain embodiments, more than one LWD module 44 and/or MWD module 46 may be employed (e.g., as represented at position 48). References throughout to a module at position 44 may also mean a module at position 48 as well.

For example, in certain embodiments, an LWD module 44 may be housed in a special type of drill collar, as is known in the art, and may include one or more of a plurality of known types of logging tools (e.g., an electromagnetic logging tool, a nuclear magnetic resonance (NMR) tool, and/or a sonic logging tool). In certain embodiments, the LWD module 44 may include capabilities for measuring, processing, and storing information, as well as for communicating with surface equipment 50 (e.g., including all of the equipment above the surface 52 of the wellsite illustrated in and described with reference to FIG. 1). In particular, as described in greater detail herein, the LWD module 44 may include a resistivity logging tool configured to obtain deep directional resistivity measurements that may be used by inversion algorithms to infer geometry and properties of the earth formation surrounding the well logging instrument.

In certain embodiments, an MWD module 46 may also be housed in a special type of drill collar, as is known in the art, and may include one or more devices for measuring characteristics of the well environment, such as characteristics of the drill string 16 and the drill bit 20, for example. In certain embodiments, the MWD module 46 may further include an apparatus (not shown) for generating electrical power to the downhole system, which may include a mud turbine generator powered by the flow of the drilling fluid 32. However, other power and/or battery systems may be employed. In certain embodiments, the MWD module 46 may include one or more of a variety of measuring devices known in the art (e.g., a weight-on-bit measuring device, a torque measuring device, a vibration measuring device, a shock measuring device, a stick slip measuring device, a direction measuring device, an inclination measuring device, and so forth).

In certain embodiments, MWD tools in the MWD module 46, and LWD tools in the LWD module 44 may include one or more characteristics common to wireline tools (e.g., transmitting and receiving antennas, sensors, etc.) with the MWD and LWD tools being designed and constructed to endure and operate in the harsh environment of drilling.

Various systems and methods may be used to transmit information (data and/or commands) from the downhole equipment 42 to the surface 52 of the wellsite. In certain embodiments, information may be received by one or more downhole sensors 54, which may be located in a variety of locations and may be chosen from any sensing and/or detecting technologies known in the art, including those capable of measuring various types of radiation, electric or magnetic fields, including electrodes (such as stakes), magnetometers, coils, and so forth.

In certain embodiments, information from the downhole equipment 42, including LWD data and/or MWD data, may be utilized for a variety of purposes including steering the drill bit 20 and any tools associated therewith, characterizing the formation 14 surrounding borehole 12, characterizing fluids within borehole 12, and so forth. For example, in certain embodiments, information from the downhole equipment 42 may be used to create one or more sub-images of various portions of borehole 12, as described in greater detail herein.

As described in greater detail herein, in certain embodiments, a well control system 56 may receive and process a variety of information from a variety of sources, including the downhole equipment 42 and the surface equipment 50. In addition, in certain embodiments, the well control system 56 may also control a variety of equipment, such as the downhole equipment 42 and the drill bit 20, as well as the surface equipment 50.

In certain embodiments, the well control system 56 may also be used with a wide variety of oilfield applications, including logging while drilling, artificial lift, measuring while drilling, wireline, and so forth, and may include one or more processor-based computing systems, such as a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for example, workflows for carrying out a drilling operation, algorithms and routines for processing data received at the surface 52 from the downhole equipment 42, the surface equipment 50, and so forth.

The well control system 56 may be located at the surface 52, below the surface 52, proximate to the borehole 12, remote from the borehole 12, or any combination thereof. For example, in certain embodiments, information received by the downhole equipment 42 and/or the downhole sensors 54 may be processed by the well control system 56 at one or more locations, including any configuration known in the art, such as in one or more handheld computing devices proximate or remote from the wellsite system 10, at a computer located at a remote command center, a computer located at the wellsite system 10, and so forth.

In certain embodiments, the well control system 56 may be used to create images of the borehole 12 and/or the formation 14 from information received from the downhole equipment 42 and/or from various other tools, including wireline tools. In addition, in certain embodiments, the well control system 56 may also perform various aspects of the inversion methods described herein to perform an inversion to obtain one or more desired formation parameters. In addition, in certain embodiments, the well control system 56 may also use information obtained from the inversion to perform a variety of operations including, for example, steering the drill bit 20 through the formation 14, with or without the help of a user (e.g., either instructed or autonomous).

FIG. 1 shows an example of the wellsite system 10. However, the embodiments described herein are not necessarily limited to drilling systems. For example, various embodiments described herein may be implemented with wireline systems, manufacturing facilities, midstream processing facilities, and other types of systems.

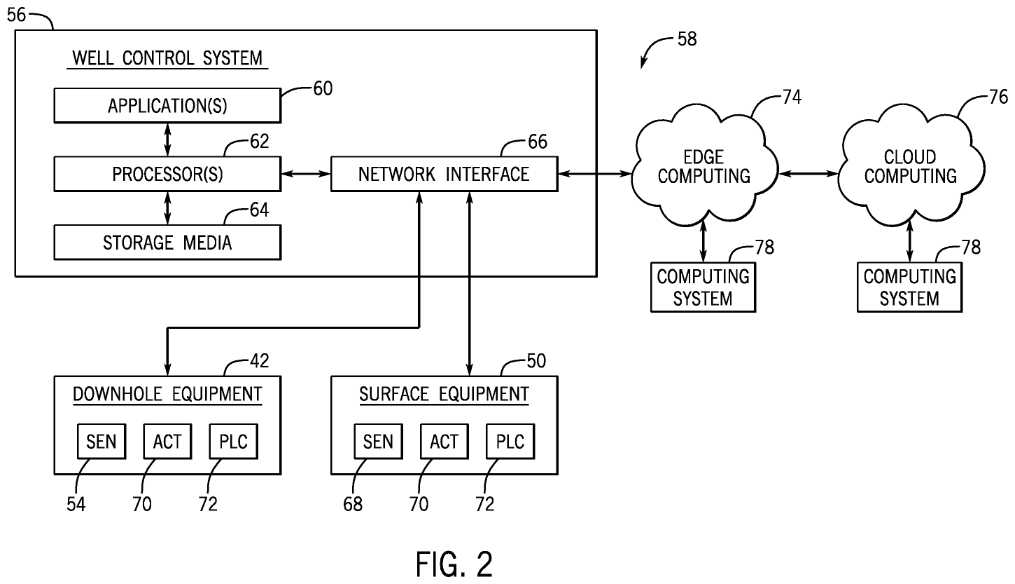

FIG. 2 illustrates a network 58 (e.g., that includes the well control system 56) configured to facilitate communication and distribute work between different computing systems of the wellsite system 10 of FIG. 1. In certain embodiments, the well control system 56 may include one or more applications 60 (e.g., a program of computer-executable instructions and associated data) that may be configured to perform various functions of the embodiments described herein. In certain embodiments, to perform these various functions, the one or more applications 60 may execute (e.g., run) on one or more processors 62 of the well control system 56, which may be connected to one or more storage media 64 of the well control system 56. Indeed, in certain embodiments, the one or more applications 60 may be stored in the one or more storage media 64.

In certain embodiments, the computer-executable instructions of the one or more applications 60, when executed by the one or more processors 62, may cause the one or more processors 62 to generate one or more models (e.g., forward model, inverse model, mechanical model, and so forth). Such models may be used by the well control system 56 to predict values of operational parameters that may or may not be measured (e.g., using gauges, sensors) during well operations. Furthermore, the one or more applications 60 may generate or receive an output of a model. The model may utilize machine learning techniques, such that the output of the model includes an inference based on input data to the model. The input data may be provided by a data source located near the well control system 56, such as cameras, sensors (e.g., the downhole sensors 54), machine telemetry, user inputs, and outputs of other models. As discussed in further detail below, the one or more applications 60 may receive input data and employ the processor 62, the edge computing resources 74, and/or the cloud computing resources 76 to produce an inference which provides actionable insight (e.g., machine health, fall detection, inventory status) for operation of the wellsite system 10.

The input data may correspond to training data used to create the model. As such, the input data may include any data which correlates with the output of the model. For example, the input data may include sensor data (e.g., temperature, pressure, radiation, acceleration, orientation, and the like), image data (e.g., a live camera feed), machine status data (e.g., maintenance status, current, voltage, and the like), audio data, and any other data associated with the well control system 56. The output of the model may be any inference determined based on the input data. For example, the output of the model may predict equipment failure, detect worker injury, identify vehicles, recommend operational parameters, automatically adjust operational parameters, and the like. Although the techniques described herein are related to operation of the well control system 56, these techniques may apply to any system requiring machine learning functionality at the edge of a network 58.

In certain embodiments, the one or more processors 62 may include a microprocessor, a microcontroller, a processor module or subsystem, a programmable integrated circuit, a programmable gate array, a digital signal processor (DSP), or another control or computing device. In certain embodiments, the one or more processors 62 may include machine learning and/or artificial intelligence (AI) based processors. In certain embodiments, the one or more storage media 64 may be implemented as one or more non-transitory computer-readable or machine-readable storage media. In certain embodiments, the one or more storage media 64 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the application(s) 60 may be provided on one computer-readable or machine-readable storage medium of the storage media 64, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 64 may be located either in the machine running the machine-readable instructions, or may be located at a remote site from which machine-readable instructions may be downloaded over a network 58 for execution.

In certain embodiments, the processor(s) 62 may be connected to a network interface 66 of the well control system 56 to allow the well control system 56 to communicate with the multiple downhole sensors 54 and surface sensors 68, as well as communicate with actuators 70 and/or PLCs 72 of the surface equipment 50 and of the downhole equipment 42 of the BHA 18, as described in greater detail herein. In certain embodiments, the network interface 66 may also facilitate communication of data, requests, and commands between the well control system 56 and other computing systems including edge computing resources 74 and cloud computing resources 76.

A portion of the network 58 including the well control system 56 and the edge computing resources 74 may be considered an edge of the network 58. The edge refers to computing resources (e.g., processors, data storage, hardware accelerators) located locally to the well control system 56, as opposed to computing resources provided remotely (e.g., the cloud computing resources 76, centralized data centers). At the edge, computing resources may connect to one another via a local area network (LAN), wired connections, and/or any other suitable connection methods. Additionally, elements at the edge may connect to the cloud computing resources 76 via internet, a wide area network, and the like. Because the edge computing resources 74 are located near the well control system 56, transferring data therebetween may be faster, cheaper, and more secure than transferring data to the cloud computing resources 76.

It should be appreciated that the network 58 illustrated in FIG. 2 is only one example of a well control system, and that the network 58 may have more or fewer components than shown, may combine additional components not depicted in the embodiment of FIG. 2, and/or the network 58 may have a different configuration or arrangement of the components depicted in FIG. 2. Some embodiments may include multiple well control systems 56, each running the same or different applications 60, and each connected to the same or different edge computing resources 74 and cloud computing resources 76. In addition, the various components illustrated in FIG. 2 may be implemented in hardware, software, or a combination of both hardware and software, including one or more signal processing and/or application specific integrated circuits. Furthermore, the operations of the network 58 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

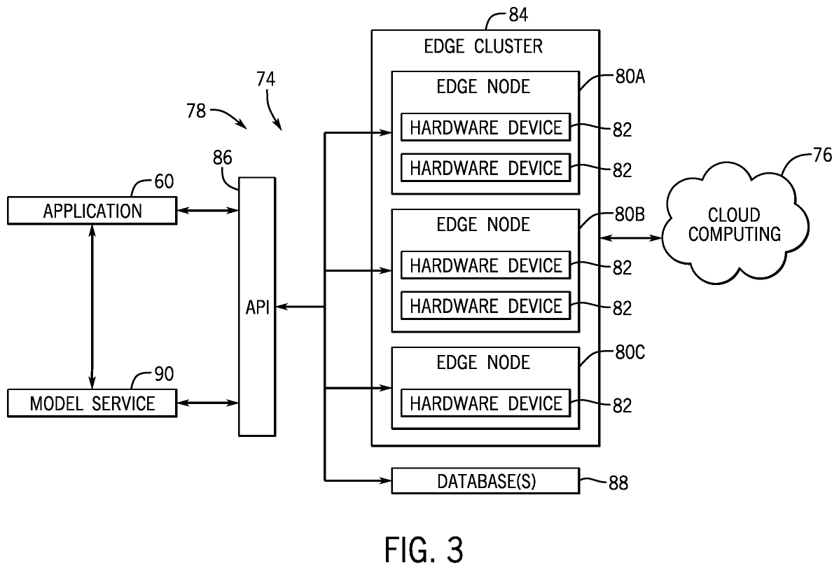

As described in greater detail herein, the applications 60 of the well control system 56 may be configured to access inference as a service (IaaS) nodes that are at least partially provided by edge computing resources 74, as described in greater detail herein. FIG. 3 illustrates an edge-based inference service system 78 that, for example, enables an application 60 of a well control system 56 to access one or more edge computing resources 74 and, in certain embodiments, one or more cloud computing resources 76, for example, via a communication network 58 to enable the IaaS techniques described in greater detail herein. As illustrated in FIG. 3, the edge computing resources 74 may include multiple edge computing resource nodes 80 accessible by the application 60. In this way, the edge-based inference service system 78 may utilize the edge computing resources 74 to handle some or all of the computing load of the application 60.

In general, the edge computing resource nodes 80 may provide a method to reduce network latency and bandwidth issues by performing basic/preliminary data processing and analysis at the edge of a central network 58, relatively near the well control systems 56. By shifting at least a portion of computing power closer to the origin of data (e.g., from the well control systems 56), the latency or communication bandwidth issues may be eliminated or reduced. For example, when the well control systems 56 have insufficient connectivity to be seamlessly communicated with the cloud computing resources 76, the edge computing resource nodes 80 may provide real-time data processing to avoid latency issues between networks (e.g., via the Internet) that may affect the performance of the well control systems 56. More specifically, including at least a portion of the IIAS functionality described herein at the edge computing resource nodes 80 may enable improved provision to the inference information described in greater detail herein.

Each of the edge computing resource nodes 80 may be any computing machine acting as a server to provide at least part of one or more inference services to the application 60. For example, a first edge computing resource node 80A may be an industrial PC, and a second edge computing resource node 80B may be a smart gateway device. Each of the edge computing resource nodes 80 has one or more hardware devices 82, some which may be specialized to handle certain tasks or parts of tasks. These certain tasks may make up an inference service assigned to the edge computing resource node 80, such that inference services across multiple edge computing resource nodes 80 collectively enable the edge-based inference service system 78. For example, hardware devices 82 of the first edge computing resource node 80A may include a graphics processing unit (GPU) and a camera, while hardware devices 82 of the second edge computing resource node 80B may include an edge accelerator and a field programmable gate array (FGPA). The hardware devices 82 may be heterogeneous across the edge computing resources 74. That is, various hardware devices 82 may independently or collectively enable the same application 60, despite each of the hardware devices 82 being different species of hardware, running on separate machines, performing different functions, having different programming interfaces, and relying on different inference framework APIs. For example, the hardware devices 82 may include any combination of central processing units (CPUs), graphics processing units (GPUs), tensor processing units (TPUs), vision processing units (VPUs), neural processing units (NPUs), other machine learning hardware accelerators, and the like. The hardware devices 82 may include an assortment of different chip architectures, such as AMD-64, microprocessor without interlocked pipelined stages (MIPS), and reduced instruction set computer (RISC) based processors. Generally, a developer may interface with these hardware devices 82 via proprietary software interfaces (e.g., libraries and APIs) specific to each of the hardware devices 82. However, the present disclosure provides techniques to expose inference functionality of the edge computing resources 74 to developers via a common service-oriented architecture (i.e., the edge-based inference service system 78). In this way, the inference functionality may be abstracted from lower level workings of the hardware devices 82, enabling streamlined development and usage of the application 60.

The application 60 may be implemented at least partially as a container executable by the edge computing resources 74. That is, the application 60 may be containerized along with software dependencies (e.g., libraries) such that the containerized application 60 performs the same regardless of its computing environment (e.g., on the edge computing resource nodes 80, via the cloud computing resources 76, on a laptop, etc.). In certain embodiments, the edge-based inference service system 78 may include a container orchestrator (e.g., Kubernetes, MicroK8S, K3S, and the like) which manages and automates workloads from one or more applications 60 performed by the edge computing resource nodes 80. The container orchestrator may define an edge cluster 84, each having one or more of the edge computing resource nodes 80. In other words, the edge computing resource nodes 80 may be grouped by the container orchestrator into the edge cluster 84. The edge-based inference service system 78 may include any number of edge clusters 84, each having any number of edge computing resource nodes 80. The container orchestrator may include a control plane configured to assign and schedule workloads of the application 60 to the edge computing resource nodes 80. An advantage of the clustering framework is that hardware and software resources of the edge computing resource nodes 80 may be dynamically included in or removed from the edge cluster 84, depending on the particular needs of the application 60. As the edge-based inference service system 78 receives requests for inference on demand, the container orchestrator may automatically distribute workloads associated with the requests to the edge computing resource nodes 80 and the hardware devices 82 which are optimally equipped to handle the workloads. For example, the container orchestrator may receive a request to classify an image, define an edge cluster 84 to include at least an edge computing resource node 80 having a neural processing unit (NPU), configure the edge computing resource node 80 to provide an image classification microservice, and direct the request to the edge computing resource node 80.

In certain embodiments, the edge cluster 84 may correspond to a group of machines physically located relatively close to the well control systems 56 in a relatively centralized manner, whereas the cloud computing resources 76 may include a plurality of remote, decentralized servers and databases. Although FIG. 3 illustrates a single application 60 serviced by a single edge cluster 84, other embodiments may include any number of applications 60 running on any number of well control systems 56. Additionally, the edge computing resources 74 may include any number of edge clusters 84, each having any number of edge computing resource nodes 80 and hardware devices 82. The container orchestrator may group multiple applications 60 into one or more pods, such that each edge computing resource node 80 is configured by the container orchestrator to run one or more of the pods. In this way, workloads of the multiple applications 60 may be managed simultaneously and efficiently by the edge computing resources 74.

The edge-based inference service system 78 may include an application programming interface (API) 86 that exposes the inference functionality of the edge computing resource nodes 80, regardless of the heterogeneous hardware devices 82 that enable the particular functionality of the edge computing resource nodes 80. The API 86 may be hosted on an API server configured to receive a request (e.g., API request) from a client device (e.g., application 60) and forward computing tasks to the edge computing resource nodes 80 based on the request. In certain embodiments, the application 60 may request (e.g., call) a machine learning output from the edge computing resources 74 via the API 86, without including code or software dependencies that are typically utilized to interface with the hardware devices 82. For example, the API 86 may map libraries and tools of each of the hardware devices 82 to a common set of calls (e.g., subroutines, methods, requests, endpoints, and the like). In this way, the API 86 may hide the heterogeneity of the edge computing resources 74 behind a layer of abstraction, such that the developer may utilize the hardware devices 82 via the API 86 without needing to know internal details of how the hardware devices 82 work. For example, the developer may request an inference by calling “request_inference(data[ ], model)” through the API 86. Then, the edge computing resources 74 may use the API 86 to interpret the request and distribute the workload associated with the request to one or more suitable edge computing resource nodes 80. In this way, the API 86 exposes the edge computing resources 74 to the application 60 as a service on demand.

The edge computing resources 74 may further include one or more databases 88 accessible to the application 60 via the API 86. The database(s) 88 may be stored on a dedicated database server, or the edge computing resource nodes 80 may include data storage devices to store the database(s) 88. Data stored on the database(s) 88 may include any data which supports the operation of the edge-based inference service system 78 described herein. For example, the database(s) 88 may include documentation, licensing information, security information, and the like. In certain embodiments, the database(s) 88 may be stored on the cloud computing resources 76, or the database(s) 88 may be stored on the storage media 64 of the well control system 56.

In certain embodiments, the edge-based inference service system 78 may include a model service 90 accessible by the application 60. The model service 90 may provide pre-trained models, model evaluation tools, model templates, data pre-processing methods, and/or additional APIs to the application 60. In certain embodiments, the model service 90 may be hosted on the cloud computing resources 76, from which the application 60 may request modelling related data on demand. In other embodiments, the model service 90 may be hosted on the edge computing resources 76, such as the edge computing resource node 80 or the database 88.

In certain embodiments, the edge computing resources 74 may be communicatively connected to the cloud computing resources 76. In particular, the cloud computing resources 76 may handle tasks that require greater compute power, higher latency, and/or lower security than the edge computing resources 74 provide. The cloud computing resources 76 may include cloud-based servers and data centers located remotely from the well control system 56. Similarly to the edge computing resources 74, the cloud computing resources 76 may utilize a container orchestrator and a clustering framework to manage nodes executing pods of containers across a cloud network.

Upon receiving inference results generated by the edge computing resources 74, the well control system 56 may respond in a number of different ways. In certain embodiments, the well control system 56 may generate a visualization to present the inference results on a display or another user interface. In other embodiments, the well control system 56 may use the inference results to automatically control equipment of the wellsite system 10, such as the downhole equipment 42 and the surface equipment 50. The well control system 56 may perform feedback control (e.g., PID control) using the inference results in substantially real time.

By way of one non-limiting example, the application 60 may be an accident detection application based on computer vision. The well control system 56 may receive image data (e.g., a live video feed) from one or more cameras located throughout the wellsite system 10. The application 60 may continuously monitor the image data to detect accidents, such as worker falls and injuries, dangerous machine failures, leaks, and the like. Generally, computer vision may require greater computing power than is provided by the well control system 56 on its own. Therefore, the application 60 may access edge computing resources 74 external to the well control system 56, such as the first edge computing resource node 80A (e.g., an AMD-64-based host machine, the second edge computing resource node 80B (e.g., an ARM-based host machine), and a third edge computing resource node 80C (e.g., a smart gateway device), in certain embodiments, each of which may be registered to an edge cluster 84 by the container orchestrator (e.g., Kubernetes). The first edge computing resource node 80A may contain a GPU, specifically optimized for image pre-processing tasks. The second edge computing resource node 80B may contain an NPU, specifically optimized for running a neural network. The application 60 may include a call, via the API 86, to determine whether an accident has occurred based on a portion of the image data. The API 86 may route a request to the first edge computing resource node 80A and interface with frameworks and libraries specific to the GPU to pre-process the image data. Then, the API 86 may route the request to the second edge computing resource node 80B and interface with frameworks and libraries specific to the NPU to detect an accident in the image data based on an artificial neural network model. Based on the outputs of the first edge computing resource node 80A and the second edge computing resource node 80B, the application 60 may receive inference results indicating that an accident has occurred. In response, the well control system 56 may trigger an alarm and initiate an accident response protocol.

Embodiments of the techniques discussed herein are not necessarily limited to wellsite systems and drilling contexts. For example, the application 60 may monitor social distancing between workers at a manufacturing facility using vision analytics. To this end, the manufacturing facility may include manufacturing systems (e.g., industrial machinery, programmable logic controllers (PLCs), motor drives, and so forth) instead of the well control system 56. As such, the application 60 may run on computing resources of the manufacturing facility. Another application 60 may use vision analytics to identify license plate numbers of vehicles in a midstream processing facility. In certain embodiments, the midstream processing facility may employ multiple applications, such as an accident detection application, a social distance monitoring application, and a license plate identification application. The multiple applications may run simultaneously on the same client device or on different client devices. Additionally, the multiple applications may have access to the same edge computing resources 74. The container orchestrator of an edge cluster 84 may distribute workloads of the multiple applications between the edge computing resource nodes 80 of the edge cluster 84, or between multiple edge clusters 84. As such, the edge-based inference service system 78 may respond to a variety of inference requests simultaneously. Furthermore, the modular nature of the edge computing resource nodes 80 and the edge clusters 84 enable dynamic scaling of the architecture of the edge computing resources 74. For example, the edge clusters 84 may dynamically incorporate more edge computing resource nodes 80 having TPUs in order to more efficiently monitor social distancing.

Although the application 60 is described herein as an element of a well control system 56, in other embodiments, the application 60 may run on any client device of the edge-based inference service system 78 for any suitable inference task. That is, the well control system 56 of a wellsite system 10 is only one example of a client device of many possible client devices. For example, client devices running the application 60 may include a smartphone, a PC, a robot, industrial automation equipment, a smart home appliance, and any other edge device utilizing machine learning.

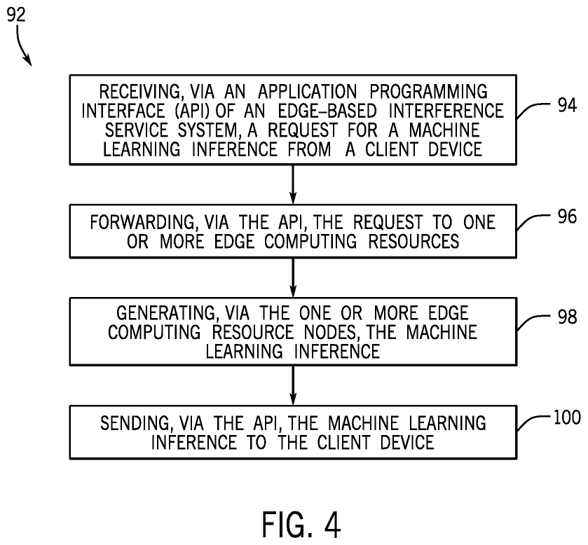

FIG. 4 is a flow diagram of a method 92 of operating the edge-based inference service system 78 described herein. As illustrated, in certain embodiments, the method 92 may include receiving, via the API 86 of the edge-based inference service system 78, a request for a machine learning inference from a client device (e.g., a well control system 56, in certain embodiments) (step 94). In addition, in certain embodiments, the method 92 may include forwarding, via the API 86, the request to one or more edge computing resources 74 (step 96). The one or more edge computing resources 74 may include one or more edge computing resource nodes 80. In addition, the API 86 may be configured to interface with one or more hardware devices 82 of the one or more edge computing resource nodes 80 based on the request. In addition, in certain embodiments, the method 92 may include generating, via the one or more edge computing resource nodes 80, the machine learning inference (step 98). In addition, in certain embodiments, the method 92 may include sending, via the API 86, the machine learning inference to the client device (step 100).

In addition, in certain embodiments, the one or more edge computing resource nodes 80 may include a plurality of edge computing resource nodes 80, each edge computing resource node 80 configured to provide a different type of machine learning inference than other edge computing resource nodes 80 of the plurality of edge computing resource nodes 80. In addition, in certain embodiments, each edge computing resource node 80 includes different sets of hardware devices 82 configured to provide the respective different types of machine learning inferences. In addition, in certain embodiments, the API 86 includes a mapping of libraries and tools of the hardware devices 82 to an abstracted set of calls that are exposed to the client device by the API 86.

In addition, in certain embodiments, the method 92 may include managing and automating workloads between the one or more one or more edge computing resource nodes 80 using a container orchestrator of the edge-based inference service system 78. In addition, in certain embodiment, the method 92 may include grouping the one or more edge computing resource nodes 80 into one or more edge clusters 84 using the container orchestrator.

In addition, in certain embodiments, generating, via the one or more edge computing resource nodes 80, the machine learning inference may include accessing data stored in one or more databases of the edge-based inference service system 78. In certain embodiments, the one or more databases store documentation, licensing information, security information, or some combination thereof.

In addition, in certain embodiments, receiving, via the API 86, the request for the machine learning inference from the client device may include receiving the request from a model service 90 of the edge-based inference service system 78. The model service may include pre-trained models, model evaluation tools, model templates, data pre-processing methods, additional APIs, or some combination thereof.

In addition, in certain embodiments, the client device may include a well control system 56, and the method 92 may include automatically controlling equipment 42, 50 of the well control system 56 based at least in part on the machine learning inference.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method comprising:
receiving, via an application programming interface (API) of an edge-based inference service system, a request for a machine learning inference from a client device;
forwarding, via the API, the request to one or more edge computing resources, wherein the one or more edge computing resources comprise one or more edge computing resource nodes, and wherein the API is configured to interface with one or more hardware devices of the one or more edge computing resource nodes based on the request;
generating, via the one or more edge computing resource nodes, the machine learning inference; and
sending, via the API, the machine learning inference to the client device.

2. The method of claim 1, wherein the one or more edge computing resource nodes comprise a plurality of edge computing resource nodes, each edge computing resource node configured to provide a different type of machine learning inference than other edge computing resource nodes of the plurality of edge computing resource nodes.

3. The method of claim 2, wherein each edge computing resource node comprises different sets of hardware devices configured to provide the respective different types of machine learning inferences.

4. The method of claim 3, wherein the API comprises a mapping of libraries and tools of the hardware devices to an abstracted set of calls that are exposed to the client device by the API.

5. The method of claim 1, comprising managing and automating workloads between the one or more one or more edge computing resource nodes using a container orchestrator of the edge-based inference service system.

6. The method of claim 5, comprising grouping the one or more edge computing resource nodes into one or more edge clusters using the container orchestrator.

7. The method of claim 1, wherein generating, via the one or more edge computing resource nodes, the machine learning inference comprises accessing data stored in one or more databases of the edge-based inference service system.

8. The method of claim 7, wherein the one or more databases store documentation, licensing information, security information, or some combination thereof.

9. The method of claim 1, wherein receiving, via the API, the request for the machine learning inference from the client device comprises receiving the request from a model service of the edge-based inference service system, wherein the model service comprises pre-trained models, model evaluation tools, model templates, data pre-processing methods, additional APIs, or some combination thereof.

10. The method of claim 1, wherein the client device comprises a well control system.

11. The method of claim 10, comprising automatically controlling equipment of the well control system based at least in part on the machine learning inference.

12. An edge-based inference service system, comprising:
one or more edge computing resource nodes; and
a client device configured to interface with the one or more edge computing resource nodes via an application programming interface (API) by:
forwarding, via the API, a request for a machine learning inference to one or more hardware devices of the one or more edge computing resource nodes; and
receiving, via the API, the machine learning inference generated by the one or more edge computing resource nodes.

13. The edge-based inference service system of claim 12, wherein each edge computing resource node of the one or more edge computing resource nodes is configured to provide a different type of machine learning inference than other edge computing resource nodes of the one or more edge computing resource nodes.

14. The edge-based inference service system of claim 13, wherein each edge computing resource node comprises a respective different set of hardware devices configured to provide the respective different types of machine learning inferences.

15. The edge-based inference service system of claim 12, comprising a container orchestrator configured to manage and automate workloads of the one or more edge computing resource nodes.

16. An edge-based inference service system, comprising:
a client device; and
a network of edge computing resources configured to:
receive, via an application programming interface (API), a request for a machine learning inference from the client device;
assign, via the API, a workload to one or more edge computing resource nodes of the network based on the request and based on one or more respective hardware devices associated with the one or more edge computing resource nodes;
generate, via the one or more edge computing resource nodes, the machine learning inference; and
send, via the API, the machine learning inference to the client device.

17. The edge-based inference service system of claim 16, wherein the client device comprises a well control system configured to control a wellsite system based on the machine learning inference.

18. The edge-based inference service system of claim 16, wherein each hardware device of the one or more respective hardware devices is specialized for a respective type of workload, and the workload is assigned to the one or more edge computing resource nodes based on the respective type of workload of the respective hardware devices of the one or more edge computing resource nodes.

19. The edge-based inference service system of claim 16, comprising a server configured to execute a model service, wherein the edge computing resource nodes are configured to generate the machine learning inference based on pre-trained models, model evaluation tools, model templates, data pre-processing methods, additional APIs, or some combination thereof provided by the model service.

20. The edge-based inference service system of claim 16, wherein the API comprises a mapping of libraries and tools of the one or more respective hardware devices to an abstracted set of calls that are exposed to the client device by the API.
